(19) United States
(12) Patent Application Publication
(10) Pub. No.: US 2007/0071783 A1
(43) Pub. Date: Mar. 29, 2007

(54) Pheromone attractants for the green mirid

(76) Inventors: Alice Del Socorro, Armidale NSW (AU); Peter Gregg, Armidale NSW (AU); Samuel Lowor, New Tafo (GH)

Correspondence Address: MOORE & VAN ALLEN PLLC, P.O. BOX 13706, Research Triangle Park, NC, 27709, US

(21) Appl. No.: 11/477,123

(22) Filed: Jun. 28, 2006

(30) Foreign Application Priority Data
Nov. 11, 2005 (AU) 2005/232292
Nov. 12, 2004 (AU) 2004/906490

(51) Int. Cl. A01N 25/00; A01N 37/02

(52) U.S. Cl. 424/405; 514/546

(57) ABSTRACT

A pheromone attractant composition for attracting the green mirid, Creontiades dilutus (St\dot{a}l), comprising as the component active in attracting green mirids an effective amount of an admixture of hexyl hexanoate and (E)-2-hexenyl hexanoate.

### TECHNICAL FIELD

The present invention relates to pheromone attractants for attracting the green mirid, Creontiades dilutus (St\dot{a}l), and the use of pheromone attractants in the control of green mirids such as in an attract-and-kill strategy or through monitoring, or mating disruption for pest management.

### BACKGROUND ART

The green mirid, Creontiades dilutus (St\dot{a}l) falls under the true bugs (order Hemiptera, suborder Heteroptera), which are characterised by piercing and sucking mouthparts. The green mirid was identified in the early 70s as a pest of cotton and is an endemic Australian species, not known from other countries. It is widely distributed in Australia. Apart from cotton it is found in many crops, lucerne, potatoes, soy beans, stone fruits, sunflower and grapes (Woodward et al. 1970, Hori & Miles 1993, Malipatil & Cassis 1997). Damage to plants results in premature abortion or deformation of fruits, leaf wilt and disease transmission. In cotton, green mirid adults prefer to feed and oviposit on plants with squares, bolls and tips.

Populations in cotton have in the past been suppressed by insecticides sprayed to control Helicoverpa spp. With an increase in the adoption of integrated pest management strategies in the cotton industry as well as the commercialization of transgenic (Bt) cotton (BOLLGARD®), insecticide use is forecast to be reduced. The status of the green mirid as a pest is therefore likely to increase. Current insecticides used against the green mirid are disruptive. They affect natural enemy populations, and a lack of “soft options” for the green mirid has been identified as a limitation for integrated pest management in cotton.

Green mirid biology, behaviour, and ecology including population dynamics, sources, host plants and movements have already been studied (Khan 1999; Miles 1995), but the sex pheromones have not been identified. If such pheromones could be identified and incorporated in lures, they could be useful for attract and kill, for mating disruption, or for monitoring the green mirid population for other control mechanisms to be applied. The green mirid is a particularly suitable target for attract-and-kill compared to, for example, Helicoverpa spp. because the damage is not restricted to the immature stages—the adults, including adult males, can cause direct injury.

Similarly, there is an urgent need for good methods of monitoring the green mirid. The insects are mobile, difficult to spot in crops, and easily disturbed. There is a lack of information on economic thresholds. Consequently, damage often occurs before growers are aware of the presence of mirids, and spraying is based on detection rather than on quantitative assessment of their abundance.

Bug pheromone systems are less well studied than those of moths such as Helicoverpa spp. As with many other insects, most of those studied have been shown to be multi-component. A mixture of two female-specific components, butyl butyrate and (E)-2-butenyl butyrate in a ratio of 94:6 have been identified in the mullein bug, Campylomma verbasci, which belongs to the same family as the green mirid. In field studies, lures were found to be as attractive as five live virgin females when released at rates of 91 and 183 μL per day (Smith et al. 1991;McBrien et al. 1994). The individual components on their own were found to be inactive. Attraction to live females, crushed females and volatiles of females feeding on mullein, Verbascum thapsis L. was also observed. (Thistlewood et al. 1989)

The pests of pistachio, Phytocoris californicus and Phytocoris relativus, on the other hand use a 2:1 ratio of hexyl acetate, which is produced by both sexes, with the female-specific compounds (E)-2-octenyl acetate and (E)-2-octenyl butyrate respectively (Millar & Rice 1998; Millar et al. 1997). While (E)-2-octenyl acetate did not inhibit P. relativus males(Millar & Rice 1998), (E)-2-octenyl butyrate inhibited attraction of P. californicus males to traps. These species belong to a different family of bugs, the Phytocoridae.

### SUMMARY OF THE INVENTION

The present inventors have established the identity of the pheromone attractants for the green mirid, Creontiades dilutus (St\dot{a}l), and found that the pheromone attractant composition comprises an admixture of hexyl hexanoate and (E)-2-hexenyl hexanoate, but have established that application of (E)-2-hexenyl hexanoate, alone maybe effective in attracting green mirids. This discovery suggests strategies for management of the pest for use as part of a pest management strategy.

According to a first aspect of the present invention there is provided a pheromone attractant composition for attracting the green mirid, Creontiades dilutus (St\dot{a}l), comprising as the component active in attracting green mirids an effective amount of an admixture of hexyl hexanoate and (E)-2-hexenyl hexanoate.

According to a second aspect of the present invention there is provided a method for attracting male green mirids, Creontiades dilutus (St\dot{a}l), to a locus comprising applying an effective amount of (E)-2-hexenyl hexanoate to said locus.

In an embodiment the (E)-2-hexenyl hexanoate is applied in combination with hexenyl hexanoate. While it is believed that these compounds constitute the sole pheromone attractants for the green mirid, additional compounds may be applied. For example, extracts from green mirids include hydrocarbons like dodecane, tridecane, tetradecane and methyl salicylate. Furthermore, compounds known to be attractive to other insect pests may be included, and such compounds include pheromones known to be attractive to other insects, extracts from plants known to be attractive to insects and-compositions which mimic same. Equally, blends of plant volatiles wherein the compounds are singly known to be attractive to insects but not found in combination in nature as described in WO 2002/089577, the contents of which are incorporated herein by reference, may be included.

According to a third aspect of the present invention there is provided a method of killing male green mirids comprising applying (E)-2-hexenyl hexanoate to a locus to which a toxicant for green mirids has been applied or is applied.

In an embodiment the (E)-2-hexenyl hexanoate is applied in combination with hexenyl hexanoate.

In an embodiment the attractant composition is applied to only a portion of the crop, in particular to selected rows of the crop. The toxicant is also applied to this portion of the crop only, generally as a cover spray after the attractant composition has been applied and male green mirids attracted to that portion of the crop. This method involves the application of less insecticide, and hence results in lower cost and less damage to non-target species, especially beneficial insects.

In an embodiment a composition attractive to other insect pests is applied to a separate portion of the crop to give effect to an attract-and-kill strategy for green mirids and other insect pests. Alternatively, the attractive compositions can be co-formulated, or applied separately to the same portion of the crop. This will be effective, for example, where the two compositions do not affect each other's activity or where they boost activity, and even in the case where inhibition of the activity of one or the other occurs but the inhibited composition is more persistent and immediate attraction and control of that pest is not required.

In an embodiment the attractant composition is applied to the crop in admixture with the toxicant or at substantially the same time as the toxicant.

In an embodiment the toxicant is applied to a crop or a portion of the crop prior to application of the attractant composition.

According to a fourth aspect of the present invention there is provided a lure for male green mirids comprising release means adapted to store and progressively release a pheromone attractant composition for attracting the green mirid comprising, as the component active in attracting green mirids, an effective amount of an admixture of hexyl hexanoate and (E)-2-hexenyl hexanoate.

In an embodiment the release means comprises a solid matrix suitable for impregnation such that the composition may be incorporated in the matrix and dispensed over time. In an embodiment the solid matrix comprises rubber or a plastic material.

In an embodiment the release means comprise a septum, typically made of rubber, which separates a reservoir of the attractant composition from the atmosphere and through which the attractant composition may permeate or which is adapted to be pierced, for example, by a syringe or needle, or ruptured.

Since the (E)-2-hexenyl hexanoate is not applied directly to the plants in this instance, hexenyl hexanoate will be provided to ensure it is attractive.

It will be appreciated that the lure may be used in conjunction with strategies for killing the insects, but also to monitor insect numbers, and so on.

According to a fifth aspect of the present invention there is provided a method of disrupting the mating of the green mirid by applying (E)-2 hexenyl hexanoate to a portion of a crop, without insecticide, in sufficient quantities to cause male green mirids to be unable to locate females, thus preventing mating and reducing the size of the next generation.

In an embodiment the (E)-2-hexenyl hexanoate is applied in combination with hexyl hexanoate.

In an embodiment the attractant composition is applied to only a portion of the crop, in particular to selected rows of the crop, at a higher rate than required for the third aspect of the invention.

The compositions of the present invention typically include an inert carrier. Volatile compounds such as those of the invention may be formulated in a variety of inert carriers, the nature of which would be recognised by the person skilled in the art. They may be formulated in liquid or solid form, where appropriate, in a manner well understood by the person skilled in the art.

Suitable liquid carriers include but are not limited to polyols, esters, methylene chloride, alcohol (such as C₁-C₄alcohol), or vegetable oils, although vegetable oils are preferred. Suitable vegetable oils include olive oil, sesame oil, peanut oil, canola oil, cottonseed oil, corn oil, soybean oil, mineral oil, as well as methylated forms of these oils, or mixtures thereof, although canola oil is preferred. Aromatic and linear hydrocarbon solvents may also be included. The active ingredient mixture may also be incorporated in a solid substrate, such as clays, diatomaceous earth, silica, polyvinyl chloride, polystyrene, polyurethanes, ureaformaldehyde condensates, and starches. Other useful solid support matrices include expanded vermiculite and paraffinic microcrystalline or bees wax, although microcrystalline wax is preferred.

Mixtures of carriers are envisaged in the present invention and, for example, an aqueous/oil or wax mixture in which the pheromones are dissolved in a miscible vegetable oil or wax.

The formulations may include a variety of optional components or adjuvants, including but not limited to feeding stimulants, food sources, insect toxicants and other insect attractants. Yet other components which may be included in the formulation include humectants, preservatives, thickeners, antimicrobial agents, antioxidants, emulsifiers, film forming polymers and mixtures thereof. Additives which retard or slow the volatilization of the active mixture are also envisaged. Humectants may include polyols, sugar fractions (such as molasses), glycols and hygroscopic salts. Antioxidants which protect the vegetable oils and volatile components are preferred. Film forming polymers include gum rosin, latex, polyvinyl pyrrolidone, polyvinyl alcohol, polyvinyl chloride, polyethylene, polyvinyl acetate and mixtures thereof. Additional optional additives include shellac, methyl methacrylate, and mixtures thereof.

The pheromone compositions may be used in a number of ways, including monitoring or controlling insect populations. In an embodiment, the compositions may be placed within traps to monitor population changes. Precise monitoring will enable growers to reduce the number of insecticide applications when populations are low.

It is envisioned that the pheromones compositions may be used in conjunction with any type of appropriate trap or disseminator as known in the art. The composition can be applied or disseminated using a variety of convention techniques, such as in an exposed solution, impregnated into a wicking material or other substrate, or incorporated in a deodorant dispenser. Further, the components of the pheromone composition may be combined in a single dispenser provided within a single trap, or provided separately in a plurality of dispensers, all within a single trap. The attractant can be applied to the device undiluted, or formulated in an inert carrier. Volatilization can be controlled or retarded by inclusion of components as described above. Controlled, slow release over an extended period of time may also be effected by placement within vials covered with a permeable septum or cap, by encapsulation using conventional techniques, or absorption into a porous substrate.

One of ordinary skill will appreciate that the rate of release of the active ingredient mixture of the present invention may be varied by manipulation of the size of the reservoir and permeability of the matrix. The support or other delivery mechanisms of the present invention preferably provides release or volatilization of the active ingredient mixture of the invention for at least one week.

Application scenarios and methods of using the pheromone composition of the present invention also include separate application of a feeding stimulant combined with an insecticide, to plants by known methods, with the placement of the attractant composition in a manner which will attract pests to the feeding stimulant-insecticide mixture. Placement may include location in a strip in the same field which is upwind of the strip of the feeding stimulant-insecticide mixture. Another placement may involve a small area treated with the attractant composition in the centre of a larger area treated with the feeding stimulant-insecticide mixture. The attractant composition of the present invention may be applied in or on granules, plastic dispensers or wicks, for example, and may be applied parallel to sprays of a feeding stimulant-insecticide mixture. Cross-wind application may offer greater control of the insect population because of an increase in the area with effective volatile concentrations, and the foraging and ovipositing behavior in which the moths fly upwind within the plant canopy. Single point application of the attractant composition may also be used effectively, depending on the existing wind conditions. Plants which may be protected from insect pests include but are not limited to agronomically important crops such as cotton, corn, field peas, lupins, sunflowers,lucerne, soybeans and vegetables, including beans, peas and tomatoes.

In the practice of any of the above-described embodiment, an attractant is used as a trap bait or is otherwise applied to the locus of or in the vicinity of infestation in an amount effective to attract the target insect. Factors such as population density, precipitation, temperature, wind velocity, and release rate will influence the actual number of insects trapped.

### BRIEF DESCRIPTION OF THE DRAWINGS

FIG. 1 is a GC-MS trace for entrained volatiles collected from female green mirids. Compound A is hexyl hexanoate, and Compound B is (E)-2-hexenyl hexanoate; and

FIG. 2 is a graph showing the timing of green mirid catches in pheromone traps during Experiment 1. Results are expressed as mirids per trap per hour for the preceding period. Only results from green mirid traps are included since other blends in this experiment caught nothing. Black bars at the top of the graph represent the night periods.

### MODES FOR PERFORMING THE INVENTION

### EXAMPLE 1

### Laboratory Experiments

Materials and Methods

Insects

Nymphs of Creontiades dilutus (the green mirid or GM) were collected from Armidale, NSW on lucerne. They were reared through to adult on fresh beans purchased regularly from supermarkets. The rearing conditions in the insectary were 25±1° C. and 13:11 light:dark (L:D) period with the dark period or scotophase during 1830-0530 h Australian Eastern Standard Time (AEST). Adults were sexed when they emerged and the sexes placed in separate containers.

Isolation of Pheromonal Compounds

Entrainment of volatiles was done with 6 to 8 day old unmated females and males. Volatiles were collected from 3 to 4 females held in an all glass apparatus. A green bean plus a branch of lucerne was added for food. Air was drawn into the flask through a filter of activated charcoal (10 cm×2 cm; 10-18 mesh) at 60 ml/min and the volatiles were trapped on a 100 mg filter of Super Q (80/100 mesh, Alltech Associates Inc) held in place by silinised glass wool in a pasteur pipette Collection was done for 15 hours. Trapped volatiles were eluted from the filter with hexane or ethyl acetate and concentrated under a gentle stream of nitrogen before analysis.

Whole body extractions were done following the procedure of Ho & Millar (2002). Mirids were first immobilised in a freezer. The immobilised insects were then put on a small piece of filter paper held between aluminium foil. The foil was then placed on another filter paper and insects squashed by applying gentle pressure. The external filter paper was discarded and the foil and the inner filter paper were transferred using forceps into a collection chamber as described above. Air was sucked through system at 60 ml/min for 15 hours. Trapped volatiles were then eluted with hexane or ethyl acetate and concentrated as required before analysis.

Pheromone Analysis using Gas Chromatography Mass Spectroscopy

Gas chromatographic-mass spectrometric (GC-MS) analyses were conducted on gland and air extracts using a Hewlett Packard 6890 series gas chromatograph and Hp 5973 mass selective detector (Hewlett-Packard, Palo Alto, U.S.A) fitted with an HP-5MS/AT-35 (5% Phenyl Methyl Siloxane, 30 m×0.25 mm i.d., 0.25 μm film thickness; J & W Scientific, Folsom, USA/Alltech Associates Inc) fused capillary column. The carrier gas was ultrapure helium at a flow rate of 0.8 m/s. The column temperature was programmed from 40° C. (0.50 min hold) to 250° C. at 20° C./min. Temperatures of the splitless injector and the GC-MS interface were set at 280° C. and 300° C. respectively. Total run time was 30 minutes. Mass spectra were scanned from m/z 30 to 300 and acquired data were collected and analyzed on a Hewlett-Packard workstation using HP Chem/Station software. Compounds were identified by comparison of retention times with authentic standards and their mass spectra.

Results

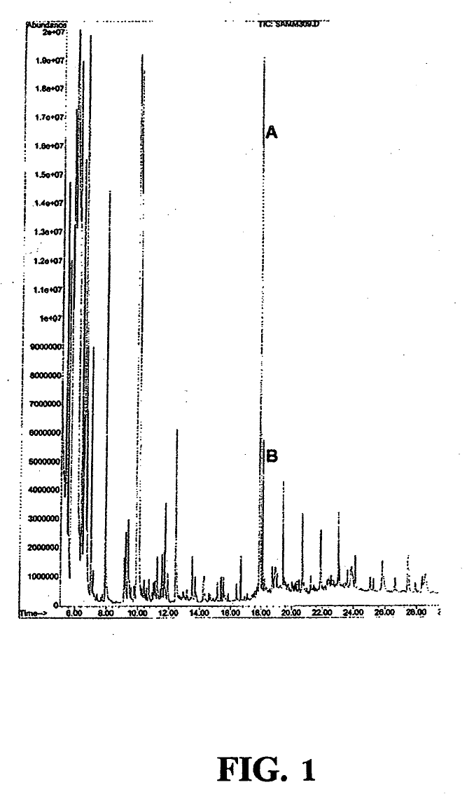

GC-MS analysis of air adsorbed and whole body extracts revealed several compounds from both virgin male and virgin female insects. Compounds were identified by comparison of mass spectral data with standard spectra and in a few cases by co-injection with authentic samples. They included hexyl hexanoate, (E)-2-hexenyl hexanoate, methyl salicylate, and hydrocarbons like dodecane, tridecane, tetradecane A typical GC-MS trace from female GM is shown in FIG. 1.

Checking for differences between the chemical profiles of female and male extracts in insects is one of the ways of determining potential sex pheromones (sex specific compounds). No sex specific compound was found in the whole body extracts analysed. Sex-specific differences however existed in the air collected samples. One of the major components in the air collections from both male and female was hexyl hexanoate. In addition, the female produced a sex specific compound, (E)-2-hexenyl hexanoate. Other compounds included hydrocarbons like dodecane, tridecane, tetradecane and methyl salicylate. Hydrocarbons may function as “wetting and spreading agents” (Blum 1978) promoting penetration of compounds like aldehydes and retard evaporation of the more potent compounds. They may also function as predator deterrents by reducing olfactory perception. Methyl salicylate acts as an anti-aphrodisiac produced by male Pieris napi butterflies, synthesised and transferred at mating (Andersson et al. 2000). Its role is however unknown in green mirid. Compounds similar to the female sex specific compound (E)-2-hexenyl hexanoate of green mirid have been reported in other bugs. For example, males of the bean bug Riptortus clavatus (Heteroptera: Alydidae) produce male specific compounds (E)-2-hexenyl-(Z)-3-hexenoate, (B)-2-hexenyl-(E)-2-hexenoate, myristyl isobutyrate and (E)-2-hexenyl hexanoate. The latter is an alarm pheromone and a blend of the others acts as aggregation pheromones attracting adults and second instar nymphs (Leal et al. 1995). In a similar species, Riptortus serripes, both males and females produced (E)-2-hexenyl hexanoate but its role as pheromone component is unknown (Aldrich et al. 1993). The only case in which hexyl hexanoate and (E)-2 hexenyl hexanoate are known as components of sex attractant pheromones is in the rice bug, Trigonotylus caelestialium, in Japan. In this species a 3-component mixture consisting of these two compounds combined with n-octyl n-butyrate was shown to attract males. All three components were found in whole-body extracts of both sexes, though the (E)-2 hexenyl hexanoate and the n-octyl n-butyrate were more abundant in females.

### EXAMPLE 2

### Field Trapping Bioassays

Materials and Methods

A series of trials involving blends of the major component, hexyl hexanoate and the minor component (E)-2 hexenyl hexanoate in various ratios, as coded and presented in Table 1, as well as the single components, were tested in a series of field trapping experiments. After the initial optimisation, two other components (methyl salicylate and (Z)-3 hexenyl acetate), found in both the male and female extracts, were tested by adding them to the optimised blend.

Lures were prepared using rubber septa. Each lure was loaded with 2 mg of the blend with 10% butylated hydroxytoluene (BHT) added as an anti-oxidant. Control lures were loaded with BHT only.

Field experiments were conducted at Cecil Plains (Qld), Narrabri, Tamworth, Mullaley and Armidale (NSW). The experimental designs were Latin Squares with treatment (pheromone blend), trap position and day as the factors. Traps were placed in a grid at intervals of 25-50 m, cleared daily, and rotated to different positions in the Latin Square designs. Delta traps made out of plastic (Corflute®) were used.

TABLE 1
Coding for blends used for optimisation.
Experiment 1: Comparison of blend GM1 with single
components GM5 and GM6

| | | (E)-2 | | (Z)-3 |
|---|---|---|---|---|
| Blend | Hexyl | hexenyl | Methyl | hexyl |
| Code | hexanoate | hexanoate | salicylate | acetate |
| GM1 | 2 | 1 | — | — |
| GM2 | 5 | 1 | — | — |
| GM3 | 10 | 1 | — | — |
| GM4 | 16 | 1 | — | — |
| GM5 | 1 | — | — | — |
| GM6 | — | 1 | — | — |
| GM7 | 1 | 1 | — | — |
| GM9 | 25 | 1 | — | — |
| GM12 | 3 | 1 | — | — |
| GM13 | 7 | 1 | — | — |
| GM14 | 5 | 1 | 1 | — |
| GM15 | 5 | 1 | — | 1 |
| GM16 | 5 | 1 | 1 | 1 |
| GM17 | 4 | 1 | — | — |
| GM19 | 6 | 1 | — | — |
| GMC | — | — | — | — |

This experiment aimed to test blends against individual components of the female sex pheromone. A 4×4 Latin square design with 4 rotation periods, 4 blend locations and 4 treatments was set up in soybeans in Cecil Plains. Traps were located 100 m from each other and cleared every day before rotation. The individual components, GM5 and GM6, and the control, did not attract any GM (Table 2). They were only caught in traps baited with the blend GM1 at an average of 3.9 males per trap. All insects caught were sexed morphologically and found to be males.

TABLE 2
Mean (± s.e) catches of the blend and individual
compounds, Experiment 1. Means followed by common letters
are not significantly different using Fisher's LSD test
(P > 0.05)

| | Mean trap |
|---|---|
| Blend | catch |
| GM1 | 3.9 ± 1.0^{a} |
| GM5 | 0.0 ± 0^{b} |
| GM6 | 0.0 ± 0^{b} |
| GMC | 0.0 ± 0^{b} |

These results show that the two compounds are needed together for the pheromone to work. GM6, the minor component unique to the female, did not attract males in the absence of the major component (GM5) produced by both sexes. This situation where the attractive blend is a mix of female component(s) and component(s) produced by both sexes has been reported in two other mirids, Phytocoris relativus and Phytocoris californicus (Millar et al. 1997, Millar & Rice 1998). The fact that only adult male GM were caught in the traps suggests that the sex pheromone is stage and species specific. The analysis of variance showed that trap position, location and interactions of these factors were not significant. Day however was significant (P<0.1), and the most significant factor influencing trap catches was the blend, P<0.001)

Experiment 2a: Optimisation of the Blend (Step 1)

In order to determine the optimal ratio of blend needed to attract males, an experiment was carried out with variations of blend GM1. It involved the use of blends GM1, GM2 and GM3, and was a 3×3 Latin Square design as described above with 3 rotations, 3 blends and 3 treatments set up in lucerne at Narrabri, NSW. There were no significant effects of trap rotation, location and day, but the analysis of variance yielded a significant effect of blend type (P<0.01) (Table 3). Comparison of the means using contrast in the R program indicated significant differences between all three blends, with blend GM2 having the highest mean catch per trap. This experiment suggested that the optimum ratio was close to 5:1 hexyl hexanoate: (E)-2 hexenyl hexanoate, which was the approximate ratio of the two compounds observed in the effluent air from female GM (FIG. 1).

TABLE 3
Mean (± s.e) catches of blends GM1, GM2 and GM3
in experiment 2a. Means followed by common letters are not
significantly different using Fisher's LSD test (> 0.05)

| Blend | Mean trap catch |
|---|---|
| GM1 | 4.22 ± 0.80^{a} |
| GM2 | 7.22 ± 1.44^{b} |
| GM3 | 2.67 ± 0.67^{c} |
| | P < 0.01 |

The same blends were again run concurrently in a rotational experiment in cotton at ACRI, Narrabri. The mean trap catches were lower than those in lucerne probably because of low numbers of GM in this advanced cotton field. The effects of day, trap rotation and location were not significant, while those of blend type were significant (P<0.01). Again, GM2 was the best blend.

TABLE 4
Mean (± s.e) catches of blends GM1, GM2 and GM3
set up in cotton. Means followed by common letters are not
significantly different using Fisher's LSD test (P > 0.05)

| Blend | Mean trap catch |
|---|---|
| GM1 | 0.0 ± 0.0^{a} |
| GM2 | 1.4 ± 0.4^{b} |
| GM3 | 0.1 ± 0.1^{c} |

Experiment 2b: Optimisation of the Blend (Step 1)

This experiment was run concurrently with experiment 2a and tested blends GM2, GM7, GM9 and the control, GMC. It was replicated twice in space in two different soy bean farms located 1 kilometre apart in Narrabri, hereafter referred to as site1 and site 2. Trap catches in these experiments were low (Tables 5 and 6). Blend type was the only significant factor influencing catches. GM2 was again the best blend. Result seems to suggest that too little of the female-specific compound (E)-2 hexenyl hexanoate in the mix reduces trap catches as seen in blend GM9, which was 25 parts of hexyl hexenoate to 1 part of (E)-2 hexenyl hexanoate.

TABLE 5
Mean (± s.e) catches of blends GM2, GM7, GM9 and
GMC at site 1. Means followed by common letters are not
significantly different using Fisher's LSD test (P > 0.05)

| Blends | Mean trap catch |
|---|---|
| GM2 | 3.0 ± 0.9^{a} |
| GM7 | 1.7 ± 0.4^{b} |
| GM9 | 0.1 ± 0.1^{c} |
| GMC | 0.0 ± 0.0^{c} |

TABLE 6
Mean (± s.e) catches of blends GM2, GM7, GM9 and
GMC at site 2 Means followed by common letters are not
significantly different using Fisher's LSD test (P > 0.05)

| Blend | Mean trap catch |
|---|---|
| GM2 | 2.0 ± 0.5 |
| GM7 | 1.8 ± 0.7 |
| GM9 | 0.0 ± 0.0 |
| GMC | 0.0 ± 0.0 |

Experiment 3: Optimisation of Blend (Step 2)

A 3×3 Latin Square experiment, replicated at two different sites in mung beans and one site in a slashed lucerne field was set up in Mullaley, NSW. This experiment involved blends GM2, GM12, GM13. In the mung beans at Site 1, blend type was the only significant factor (P<0.01). Difference between means tested using contrast from the R program indicated that blend GM2 caught significantly higher number of males than blends GM12 and GM13.

TABLE 7
Mean (± s.e) catches in mung beans, Site 1, in
experiment 3. Means followed by common letters are not
significantly different using Fisher's LSD test (P > 0.05)

| Blend | Mean trap catch |
|---|---|
| GM2 | 7.0 ± 0.8^{a} |
| GM12 | 5.2 ± 1.0^{b} |
| GM13 | 3.4 ± 1.0^{c} |

At site 2 in mung beans (Table 8), the analysis of variance did not detect any difference between the blend treatments, though GM2 again gave the highest catches.

TABLE 8
Mean (± s.e) catches in mung beans, Site 2, in
experiment 3. Means followed by common letters are not
significantly different using Fisher's LSD test (P > 0.05)

| Blend | Mean trap catch |
|---|---|
| GM2 | 7.8 ± 1.6^{a} |
| GM12 | 7.2 ± 1.6^{a} |
| GM13 | 6.2 ± 0.8^{a} |

In lucerne GM2 again gave the highest catches (Table 9. though the replicates were quite variable and the analysis of variance did not detect any difference between the blend treatments. In all these experiments, the blends GM2, GM12 and GM13 were fairly close in their proportions of the two components. The trend was for GM2 (5:1) to give the best catches, but the data suggest that the proportions are not critical within the range of 3:1 to 7:1 of hexyl hexanoate to (E)-2 hxenyl hexanoate.

TABLE 9
Mean (± s.e) catches in lucerne, experiment 3.
Means followed by common letters are not significantly
different using Fisher's LSD test (P > 0.05)

| Blend | Mean trap catch |
|---|---|
| GM2 | 7.0 ± 0.8^{a} |
| GM12 | 5.2 ± 1.0^{a} |
| GM13 | 3.4 ± 1.0^{a} |

Experiment 4: Optimisation of Blend (Step 3)

Blends GM2, GM12, GM17 and GM19 were tested in a 4×4 Latin Square experiment in lucerne at Piallamore, NSW. Results again indicated that ratios in the range of 3:1 to 6:1 of hexyl hexanoate to (E)-2-hexenyl hexanoate gave similar results (Table 10). Analysis of variance on the logarithmically transformed data indicated no significant differences (P>0.05) between the blends. The day however had a highly significant effect (P<0.01) on the trap catches.

TABLE 10
Mean (± s.e) catches in lucerne, Experiment 4.
Means followed by common letters are not significantly
different using Fisher's LSD test (P > 0.05)

| Blend | Mean trap catch |
|---|---|
| GM2 | 3.2 ± 1^{a} |
| GM12 | 2.8 ± 0.8^{a} |
| GM17 | 3.4 ± 0.8^{a} |
| GM19 | 5.1 ± 1.2^{a} |

Experiment 5: Effect of Lure Loading Effect on GM Trap Catches.

This experiment aimed at testing the effect of septa loading on trap catches. It involved the use of blend GM2 with a 2, 20 and 40 mg loading respectively. The ratio of hexyl hexanoate to (E)-2-hexenyl acetate in all blends was 5:1. The design was a 3×3 Latin Square set up at two different sites in mung beans at Mullaley, NSW. At site 1, analysis of variance showed no significant differences between trap catches for the doses 2 mg, 20 mg and 40 mg (Table 11). Trap location and day were also non significant (Table 11).

TABLE 11
Mean (± s.e) catches of blend GM2 in the
loading experiment, Site 1. Means followed by common
letters are not significantly different using Fisher's LSD
test (P > 0.05)

| Loading | |
|---|---|
| (mg) | Mean trap catches |
| 2 | 1.2 ± 0.1^{a} |
| 20 | 1.2 ± 0.4^{a} |
| 40 | 3.0 ± 1.0^{a} |

At the second site, similar results were obtained (Table 12).

TABLE 12
Mean (± s.e) catches of blend GM2 in the
loading experiment, Site 2. Means in the same column
followed by common letters are not significantly different
using Fisher's LSD test (P > 0.05)

| Loading | |
|---|---|
| (mg) | Mean trap catches |
| 2 | 4.8 ± 1.8^{a} |
| 20 | 2.2 ± 0.8^{a} |
| 40 | 2.4 ± 0.7^{a} |

Experiment 6: Effects of Methyl Salicylate and (Z)-3 Hexenyl Acetate on Blend GM2

This experiment aimed at testing the effects of methyl salicylate and (Z)-3 hexenyl acetate, identified in both male and female extracts on the optimised blend. The hypothesis was that they might increase the attractiveness of the blend. Blends GM2, GM14, GM15 and GM16 were used in a 4×4 Latin Square experiment conducted in lucerne at Piallamore, NSW. Though the effects of day were highly significant (P<0.01), the addition of methyl salicylate and (Z)-3 hexenyl acetate, together or individually, to the blend had no significant effects on the trap catches (Table 13).

TABLE 13
Mean (± s.e) catches of blends GM2, GM14, GM15
and GM16 in lucerne, Experiment 6. Means followed by
common letters are not significantly different using
Fisher's LSD test (P > 0.05)

| Blend | Mean trap catch |
|---|---|
| GM2 | 4.6 ± 0.9 |
| GM14 | 2.9 ± 1.0 |
| GM15 | 3.9 ± 0.7 |
| GM16 | 2.7 ± 0.8 |

Timing of the Response to Pheromones

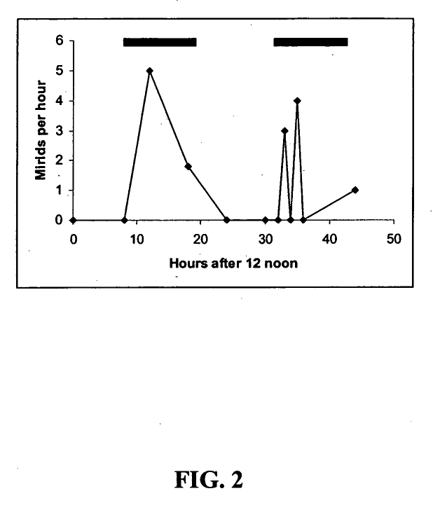

Most insects have specific times of the day or night during which they respond to pheromones. To determine this periodicity for GM, in Experiment 1 (on soybeans at Cecil Plains), the traps were inspected at regular intervals over a two day period. Results are shown in FIG. 2. in relation to the ambient photoperiod.

It is clear that GM males responded to pheromones during the night, and most strongly during the early part of the night. In these experiments the nights were reasonably warm (sunset temperature about 20° C.). It is possible that this behavioural pattern might be different if the temperature at sunset was too low for insect activity.

Summary and General Conclusions of the Trapping Experiments

The major sex attractant components produced by adult females of GM have been isolated and identified as a result of studies utilising gas chromatography-mass spectrometry analysis and field bioassays. The pheromone is sex specific and synthesised pheromone was attractive to only adult male C. dilutus. It consistently caught GM in a range of crops (cotton, lucerne, soybeans and mung beans) at a wide range of sites in NSW and Qld.

Thirteen synthetic blends of the major component, hexyl hexanoate and the minor component (E)-2-hexenyl hexanoate in various ratios as well as the single components were tested at various times in the field in an attempt to select the best and optimal blend. Results from the optimisation process indicated that the two compounds are needed together for the pheromone to work. Blend GM6, being the minor component unique to the female could not attract any male in the absence of the major component (GM5) produced by both sexes. Blends GM2, GM12, GM17 and GM19 statistically had the same effectiveness in attracting males to traps. The optimum ratio therefore appears to be about 5:1 of the major component hexyl hexanoate to the minor component, (E)-2-hexenyl hexanoate, but this ratio does not appear to be critical, since blends in the range of 3:1 to 7:1 worked just as well. Two other components (methyl salicylate and Z3-hexenyl acetate), found in both the male and female extracts, when added to the optimised blend did not significantly enhance the trap catches. A dose response trial of doses ranging from 2 mg to 40 mg carried out with the optimal blend did not show any significant effect of loading on trap catches. It would therefore appear that blends similar to GM2 have the potential for development as a commercial pheromone for GM.

GM males appear to respond to pheromones in the night, especially the early part of the night, at least when the temperatures are high enough to permit night flight. During the Mullaley experiments (3-5), which were conducted in March 2004 when night temperatures were relatively low, there were indications that the catch was reduced. This suggests that responses to pheromones are temperature-sensitive, as they are in many other species. This effect has not been analysed in the current experiments because no accurate temperature recordings were taken.

### EXAMPLE 3

### Attract-and-Kill Experiments

Experiment 1—Added Insecticide

This experiment was designed to investigate whether the mirid pheromone components identified by the laboratory and field trapping experiments described above could be used in combination with an insecticide for attract-and-kill.

Materials and Methods

The trial was set up in late flowering pigeon peas near Mullaley, NSW. The pheromone components were mixed with the formulation base from Magnet®, the commercial embodiment of the compositions described in WO 02/089577, the contents of which are incorporated herein by reference. This mixture is shown in Table 14:

TABLE 14
Carrier for pheromone components in the
attract-and-kill trial.

| | | | Max. | |
|---|---|---|---|---|
| Ingredient | CAS No. | Purpose | (%) | Supplier |
| Canola oil | | Carrier^{#} | 20.0 | Various |
| (food grade) | | | | |
| Sucrose (food | 57-50-1 | Feeding | 20.0 | Various |
| grade) | | stimulant | | |
| Sorbitan | 1338-41-6 | Emulsifier | 2.0 | APS Cotter |
| monostearate | | | | Food |
| | | | | Services |
| Xanthan gum | 11138-66-2 | Thickener | 0.1 | Sigma- |
| | | | | Aldrich |
| Vitamin E | 10191-41-0 | Antioxidant | 0.1 | Lancaster |
| | | | | or Sigma- |
| | | | | Aldrich |
| butylated | 128-37-0 | Antioxidant | 0.1 | Lancaster |
| hydroxytoluene | | | | |
| Brilliant Blue | 2650-18-2 | Marker | 0.1 | Queen Fine |
| (food colour | | | | Foods |
| 133) | | | | |
| Water | 7732-18-5 | Extender | 50.0 | Various |

The plant volatile components of Magnet® were not included. The toxicant was methomyl at a concentration of 0.5% active ingredient.

There were four treatments:
1) Control (no pheromone components added; carrier only)
2) 12 ml hexyl hexanoate added to 500 ml of carrier
3) 12 ml (E)-2 hexenyl hexanoate added to 500 ml of carrier
4) 10 ml hexyl hexanoate plus 2 ml (E)-2 hexenyl hexanoate added to 500 ml carrier

Thus, in treatments 2-4 the final concentration of volatile pheromone components was about 2.3%. Treatment 4 had the two components in the optimum ratio as determined by trapping experiments.

Approximately 100 ml of each mixture was applied to 5 m of row of the pigeon peas, being shaken from a plastic bottle onto the tops of the plants. There were three replicates of each treatment, with buffer zones of 20 m surrounding them. Black plastic weed mat, 90 cm wide, was placed in the furrows on both sides,of the treated rows. It was secured around the bases of the plants using clothes pegs. This was done to facilitate finding dead GM. The treated areas were searched each morning over the next three days, and any dead GM found were sexed. Two pheromone traps, using blend GM2 as previously described, were also operated near the experimental site. At the conclusion of the experiment, five replicate samples using beat sheets were taken in the vicinity of the sprayed regions.

Results

The mean numbers of GM adults and nymphs killed in each treatment are shown in Table 15.

TABLE 15
Mean numbers of male and female adults, and
nymphs of green mirids found in the four treatments in the
attract-and-kill experiment. Figures in brackets are
standard errors of the means.

| | Day 1 | | | Day 2 | | |
|---|---|---|---|---|---|---|
| | | Female | | Male | Female | |
| Treatment | Male adult | adult | Nymph | adult | adult | Nymph |
| Control | 1.0 (0.6) | 0.7 (0.3) | 0 | 0.3 | 0 | 0 |
| | | | | (0.3) | | |
| Hexyl | 1.3 (0.3) | 1.3 (0.3) | 0.3 | 0 | 0 | 0 |
| hexanoate | | | | (0.3) | | |
| (E)-2 | 3.0 (1.1) | 1.0 (1.0) | 0.3 (0.3) | 1.3 | 0 | 0 |
| hexenyl | | | | (0.9) | | |
| hexanoate | | | | | | |
| 5: 1 | 2.3 (1.5) | 1.0 (0.6) | 0.7 (0.7) | 1.7 | 0 | 0 |
| blend | | | | (0.3) | | |

The numbers killed were very low. In part this probably reflects a low GM density in the field where the experiments were done. The two sentinel pheromone traps operated during the two days caught no GM. The five beat-sheet samples done after the second day revealed only two females GM in total, for the 5 m of row sampled. Furthermore, the temperatures at sunset were low (<10° C.), and there were indications from the trapping work described earlier that low temperatures were associated with poor response to the pheromones.

Nevertheless, there were indications that the formulations were attracting and killing male GM. On the first day, the numbers of male GM killed were highest in the formulations which contained (B)-2 hexenyl hexanoate, though not significantly so (F_{3,8}=1.05, P=0.42). The numbers of females and nymphs killed were similar in all treatments. These females and nymphs, along with the males in the control treatment and some males in the other treatments, were probably insects which were resident on the treated sections of row when the formulations were applied. Their numbers were roughly consistent with the beat sheet samples. On the second day, no female adults or nymphs were found, presumably because they had all been killed on the first day. However, males were found, and the absence of females and nymphs suggests that they were not resident males, but had come to the treated sections in response to the pheromone. Numbers of males again tended to be higher in the treatments which contained (E)-2 hexenyl hexanoate, though again the differences between treatments were not statistically significant (F_{3,8}=2.52, P=0.13). When a GLIM analysis was performed on the combined data set, with day and treatment as factors, treatment was close to significant (F_{3,16}=2.62, P=0.086). When the data for males was pooled over the two days, and treatments 1-and 2 (without (E)-2 hexenyl hexanoate) were compared with those containing it (treatments 3 and 4), there was a statistically significant difference (F_{1,10}=5.67, P=0.04)

These results suggest that the critical component for attract-and-kill to work with sprayed-on formulations is the female-specific component of the pheromone blend, (E)-2-hexenyl hexanoate, and that it will work alone. This result is in contrast to the situation in traps, where both this component and the gender non-specific compound hexyl hexanoate were needed. The difference may reflect the amount of the latter compound which was present in the atmosphere surrounding the trials, or perhaps even production of this compound by the plants (it is a green leaf volatile). It is possible that the (E)-2 hexenyl hexanoate acts as the more specific stimulus guiding male GM to mates, but only when hexyl hexanoate is present.

Another reason for the low numbers of GM killed in this trial may be that contact with the insecticide is not induced by the pheromone. Observations of mirid behaviour around traps using night vision goggles indicates that though they approach the lure closely enough to be caught in the traps, they do not contact it. Also on several occasions GM were observed close to the trap, sitting immobile in the foliage of nearby plants. It is possible that some close range stimulus, visual or chemical, is required to induce contact. The feeding stimulant sucrose, included in the Magnet® base (Table 14) to stimulate the feeding of Helicoverpa spp., does not appear to work with GM. However, the tendency of GM to closely approach pheromone sources and perch in nearby foliage suggests that they could be killed by a foliar insecticide applied to a row which is also treated with pheromone. There are a number of insecticides known to have contact activity on GM.

Experiment 2—Suction Sampling Without Insecticide Added

Materials and Methods

The trial was set up in a field of flowering faba beans at “Carbucky”, near Goondiwindi, Qld., in September 2004. Magnet® base (Table 14) was used to formulate 4 treatments:

base alone

base containing the GM pheromone blend (GM2)

GM pheromones consisted of 1% hexyl hexanoate and 0.2% (E)-2 hexenyl hexanoate. This equated to the 5:1 ratio of the GM2 blend, at a final concentration of 1.2% volatiles. No insecticide was added to any treatment.

Treatments were applied to 50 m strips of faba beans, arranged in a square pattern of four rows each containing one replicate of each treatment, with 50 m buffer strips between them. Rows were separated by 50 m. Formulations were applied to the tops of plants in each replicate by hand (shaken from a plastic bottle) at 500 ml per 50 m.

The treatments were sampled using a large backpack suction sampler (D-vac), based on a Solo Mist Blower Port 423. This machine has a sampling efficiency of 50-60% for GM in cotton (Stanley 1997). The nozzle was moved over the top of the plants at a slow walking speed and insects collected in a nylon bag, then transferred to plastic bags and frozen prior to counting. Treatments were sampled at 20, 31, 78 and 123 h post application. The 20 h sample was done in mid-morning, on the day following application, but all subsequent samples were done at night, around 2200-2300 h. This was because the trapping studies showed that most male mirids came to the pheromone in the early evening. On each sampling occasion, four control (untreated) 50 m sections were sampled from randomly chosen locations between the treated rows. The controls therefore represented sections from which insects had not been previously removed, whereas for the treated sections, most insects collected probably represent arrivals since the last sampling time.

Results

Mean numbers of male and female GM from each treatment on each sample occasion are shown in Table 16. GM numbers were very low. In the control sections they were always below 1 per 50 m. At the 20 h and 31 h samples, there were no significant differences between treatments. In the case of the 20 h sample, this may have been because males which approached the pheromone during the night left again the next morning, before the sample. For the 31 h sample, there was a tendency for more male mirids in the pheromone treatment, and the difference was almost signficant (F_{2,11}=3.76, P=0.065) and in the 78 h treatments there was a significant difference between the treatments in the case of males (F_{,2,11}=5.72, P=0.025) For the females, however, there were no significant differences. For the males, the differences were mostly due to higher numbers in the pheromone-only treatment. This treatment was significantly different from all the others using LSD tests (Table 16).

TABLE 16
Numbers of GM males and females collected by
suction sampling from 50 m sections of treated rows in the
“Carbucky” experiment. Means within the same column for
the same sampling time which are followed by common
letters are not significantly different using Fisher's LSD
test (P > 0.05)

| | Hours post | | | |
|---|---|---|---|---|
| Treatment | Spray | Males | Females | Total |
| Control | 20 | 0.00a | 0.00a | 0.00a |
| Base | 20 | 0.00a | 0.50a | 0.50a |
| Pheromones | 20 | 0.75a | 0.00a | 0.75a |
| Control | 31 | 0.25a | 0.25a | 0.50a |
| Base | 31 | 1.00a | 1.25a | 2.25a |
| Pheromones | 31 | 3.50a | 0.75a | 4.25b |
| Control | 78 | 0.25a | 0.00a | 0.25a |
| Base | 78 | 0.75a | 0.00a | 0.75a |
| Pheromones | 78 | 3.00b | 0.75a | 3.75b |
| Control | 123 | 0.25a | 0.50a | 0.75a |
| Base | 123 | 0.00a | 0.00a | 0.00a |
| Pheromones | 123 | 2.00a | 0.00a | 2.00a |
| Control | Total | 0.75a | 0.75a | 1.50a |
| Base | Total | 1.75a | 1.75a | 3.50a |
| Pheromones | Total | 8.50b | 1.50a | 10.00b |

At the final sample time, 123 h, the trends were similar to earlier samples, but the differences were not statistically significant for the males (F_{2,11}=1.88, P=0.208).

When the catches were summed over all sample intervals, there was a significant difference for males (F_{2,11}=4.98, P=0.035). Most of this was due to the pheromone-only treatment, which was significantly different from the others using LSD tests. Overall, this treatment yielded approximately 11 times the number of male GM compared to the control.

Conclusions from the Attract-and-Kill Experiments

The first experiment was done under difficult conditions, towards the end of the season, with low GM numbers and low temperatures which may have inhibited male responses to pheromones. Nevertheless, there were indications from the work that male GM can be attracted and killed with sprayed-on formulations containing (E)-2 hexenyl hexanoate, and this is consistent with the trapping experiments. Observations of the behaviour of male GM around pheromone traps and pheromone treated areas suggest that incorporating insecticide with the pheromone may not be the most effective method of control, since the mirids might not contact or ingest the material, but only sit immobile in nearby foliage. Lack of ingestion may be either because the pheromone response inhibits feeding behaviour, or because GM (with their piercing/sucking mouthparts) will not ingest liquid formulations. Lack of contact may be because some close-range stimulus, visual or olfactory, is missing from the formulations we applied.

The second experiment was also done under unfavourable conditions, early in the next season, before GM numbers had built up. The actual numbers of GM are probably an underestimate, since the suction sampler was only 50-60% efficient (Stanley 1997). Nevertheless the experiment showed a clear tendency of male (but not female) GM to accumulate in the rows treated with pheromone. If a contact foliar insecticide had been applied to these rows, it would have killed them. We did not do this because dead mirids are very hard to find, especially at the densities present in this experiment. Instead we collected them live by suction sampling. Insecticides currently registered for control of GM in cotton, which have contact activity, include alpha-cypermethrin, beta-cyfluthrin, bifenthrin, chlorpyrifos-methyl, deltamethrin, dimethoate, endosulfan, fipronil, imidacloprid, lambda-cyhalothrin and omethoate (Johnson & Farrell 2003). All these insecticides damage natural enemy populations, and the ability to control GM by treating only occasional rows with them and allowing natural enemies to survive in the other rows would be a considerable advance in cotton IPM. Killing male GM would reduce damage to cotton directly (since the males themselves feed on the crop), and indirectly by removing potential mates for the females, thus reducing the next generation. The magnitude of the indirect effect would depend on the extent of multiple mating, and the ability of mated female GM to move into the crop from outside sources. Both of these factors are not well understood for GM at present.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be clearly understood that, although a number of prior art publications are referred to herein, this reference does not constitute an admission that any of these documents forms part of the common general knowledge in the art, in Australia or in any other country.

### INDUSTRIAL APPLICABILITY

The present invention is useful in integrated pest management strategies, in particular, in attract-and-kill strategies for control of the green mirid, Creontiades dilutus (St\dot{a}l).

### REFERENCES

Aldrich, J. R., Waite, G. K., Moore, C., Payne, J. A., Lusby, W. R., & Kochansky, J. P. (1993) Male-specific volatiles from Nearctic and Australasian true bugs (Heteroptera: Coreidae and Alydidae). Journal of Chemical Ecology 19, 2767-2781.

Andersson, J., Borg-Karlson, A. K., & Wiklund, C. (2000) Sexual cooperation and conflict in butterflies: A male-transferred anti-aphrodisiac reduces harassment of recently mated females. Proc. R. Soc. London B 267, 1271.

Blum M S. (1978). Biochemical defenses of insects. In: Rockstein, M Biochemistry of Insects Academic Press; New York. pp. 465-513

Hori, K & Miles P. W. 1993. The etiology of damage to lucerne by the green mirid, Creontiades dilutus (Stal). Australian Journal of Experimental Agriculture 33, 327-331.

Ho, H.-Y. & Millar, J. G. (2002). Identification, electroantennogram screening, and field bioassays of volatile chemicals from Lygus hesperus Knight (Heteroptera: Miridae). Zoological Studies 41, 311-320.

Gregg, P. C. & Del Socorro, A. P. (2002) Attractants for moths. International Patent Publication No. WO02089577 A9, 85 pp.

Johnson, A. & Farrell, T. (2003) Cotton Pest Management Guide 2003-04. Australian Cotton Cooperative Research Centre, Narrabri.

Kazizaki,M. & Sugie, H. (2001) Identification of female sex pheromone of the rice leaf bug, Trigonotylus caelestialium. Journal of Chemical Ecology 27, 2447-2457.

Khan, M N (1999) Aspects of the biology, ecology and management of the green mirid, Creontiades dilutus (St\dot{a}l) in Australian cotton. PhD thesis, University of New England

Leal, W. S., Higuchi, H., Mizutani, N., Nakamori, H., Kadosawa, T., & Ono, M. (1995) Multifunctional communication in Riptortus clavatus (Heteroptera: Alydidae): conspecific nymphs and egg parasitiod Ooencyrtus nezarae use the same adult attractant pheromone as chemical cue. Journal of Chemical Ecology 21, 973-985.

Halipatil, M B & Cassis, G. (1997) Taxonomic review of Creontiades Distant in Australia (Hemiptera: Miridae:Mirinae). Journal of Australian Entomological Society 36, 1-13.

McBrien, H L, Judd, G J R, Borden, J H & Smith, R F. (1994) Development of sex pheromone-baited traps for monitoring Campylomma verbasci (Heteroptera: Miridae). Environmental Entomology 23, 442-446.

Miles, M. (1995). Identification, pest status, ecology and management of the green mirid, Creontiades dilutus, (St\dot{a}l) (Hemiptera:Miridae), a pest of cotton in Australia. PhD thesis, University of Queensland

Millar, G J & Rice, R E. (1998) Sex pheromone of the plant bug Phytocoris californicus (Heteroptera: Miridae). Journal of Economic Entomology 91, 132-137.

Millar, J G, Rice, R E & Wang, Q. (1997) Sex pheromone of the mirid bug Phytocoris relativus. Journal of Chemical Ecology 23, 1743-1754.

Smith, R F, Pierce, H D & Borden, J H. (1991) Sex pheromone of the Mullein bug, Campylomma verbasci (Meyer) (Heteroptera: Miridae). Journal of Chemical Ecology 17, 1437-1447.

Thistlewood, H M A, Borden, J H, Smith, R F, Pierce, H D & McMullen, R D. (1989) Evidence for a sex pheromone in the mullein bug, Campylomma verbascis (Meyer) (Heteroptera: Miridae). Canadian Entomologist 121, 737-744.

Stanley, J. N. (1997) The seasonal abundance and impact of predatory arthropods on Helicoverpa species in Australian cotton fields. PhD thesis, University of New England.

Woodward T E, Evans J W & Eastop V F. (1970) Hemiptera. In: The Insects of Australia Chapter 26. Melbourne University Press, Carlton.

The claims defining the invention are as follows:

1. A pheromone attractant composition for attracting the green mirid, Creontiades dilutus (St\dot{a}l), comprising as the component active in attracting green mirids an effective amount of an admixture of hexyl hexanoate and (E)-2-hexenyl hexanoate.

2. A pheromone attractant composition as claimed in claim 1 in which the ratio of hexyl hexanoate to (E)-2-hexenyl hexanoate is in the range of 3:1 to 7:1.

3. A pheromone attractant composition as claimed in claim 2 wherein the ratio of hexyl hexanoate to (E)-2-hexenyl hexanoate is about 5:1.

4. A method for attracting male green mirids, Creontiades dilutus (St\dot{a}l), to a locus comprising applying an effective amount of (E)-2-hexenyl hexanoate to said locus.

5. A method as claimed in claim 4 wherein hexyl hexanoate is also applied to said locus.

6. A method as claimed in claim 5 wherein a composition comprising hexyl hexanoate and (E)-2-hexenyl hexanoate in a ratio of 7:1 to 3:1 is applied to said locus.

7. A method as claimed in claim 6 wherein a composition comprising hexyl hexanoate and (E)-2-hexenyl hexanoate in a ratio of about 5:1 is applied to said locus.

8. A method as claimed in claim 4 wherein a toxicant for green mirids is applied to said locus.

9. A method as claimed in claim 8 wherein said locus constitutes a portion of the crop and the toxicant is applied to this portion some time after application of (E)-2-hexenyl hexanoate and/or hexyl hexanoate.

10. A method of killing male green mirids comprising applying (E)-2-hexenyl hexanoate to a locus to which a toxicant for green mirids has been applied or is applied.

11. A lure for male green mirids comprising release means adapted to store and progressively release a pheromone attractant composition for attracting the green mirid comprising, as the component active in attracting green mirids, an effective amount of an admixture of hexyl hexanoate and (E)-2-hexenyl hexanoate.

12. A lure as claimed in claim 11 wherein said release means comprises a solid matrix impregnated with said admixture.

13. A lure as claimed in claim 11 wherein said release means comprises a compartment segregated from the atmosphere by a septum.

14. A method of disrupting the mating of the green mirid by applying (E)-2 hexenyl hexanoate to a portion of a crop, without insecticide, in sufficient quantities to cause male green mirids to be unable to locate females, thus preventing mating and reducing the size of the next generation.

15. A method as claimed in claim 14 wherein (E)-2-hexenyl hexanoate is applied in combination with hexyl hexanoate.

16. A composition for attracting male green mirids comprising an effective amount of (E)-2-hexenyl hexanoate and an inert carrier.

17. A composition for attracting male green mirids comprising an effective amount of an admixture of hexyl hexanoate and (E)-2-hexenyl hexanoate and an inert carrier.
